(19) United States
(12) Patent Application Publication
(10) Pub. No.: US 2006/0106869 A1
(43) Pub. Date: May 18, 2006

(54) Multimedia enhancement system using the multimedia database

(75) Inventors: Kuang-Rong Lu, Taipei City (TW); Aubrey Kuang-Yu Chen, Taipei City (TW)

Correspondence Address: BIRCH STEWART KOLASCH & BIRCH, PO BOX 747, FALLS CHURCH, VA, 22040-0747, US

(73) Assignee: ULEAD SYSTEMS, INC.

(21) Appl. No.: 10/989,498

(22) Filed: Nov. 17, 2004

(51) Int. Cl. G06F 17/00; G06F 7/00

(52) U.S. Cl. 707/104.1

(57) ABSTRACT

A multimedia enhancement system and process thereof are provided. There are connections among multimedia management, database and enhancement facilities. Storing facility is configured for accepting the information from a collecting facility and storing the information in a form of a plurality of descriptors. Once one of the multimedia files is requested, an enhancement on the requested multimedia file is implemented in reference to the descriptors in the storing facility.

### BACKGROUND OF THE INVENTION

1. Field of the Invention

The invention relates generally to a process and system for enhancing one or more multimedia files. In particular, the invention relates to a process and system for enhancing one or more multimedia files.

2. Background of the Invention

With the rapid development of digital media, there are more and more software applications or facilities applied on the management and enhancement of these digital media. For example, multimedia management application helps with collecting and classifying massive multimedia files, such as photo, video, audio files. There is massive original information embedded in or additive information noted into the multimedia files collected by the multimedia management application.

On the other hand, multimedia enhancement application helps with providing tools or functions to correct the massive media files. Generally, approach to enhancement of multimedia files, for example, video, music, audio, or image files, involves users to identify one or more possible problems present on the multimedia files first. Next, it is necessary for users to decide the suitable tools or functions and the order while they are used to improve the multimedia files. Nevertheless, these two processes aforementioned are related with the knowledge of users on the field. For example, if there are some buildings and a green land in front of the buildings displayed in a photo, an operator must identify the photo as a landscape photo first, determine whether exposure issue happens in the photo and then enhance the photo by selecting and suitable tools or functions and arranging the suitable order in use for exposure issue. It is usually a trial-and-error process and the final result on the enhanced photo varies depending on the operator's expertise in the photography domain and his/her familiarity with the current multimedia enhancement application. Accordingly, it is inevitable to take many trivial decision processes even for a professional user with these conventional multimedia enhancement applications. On the other hand, the final enhanced result is also highly subjective and is difficult to repeat in subsequent processes.

Actually, there have been many different multimedia databases containing valuable data from the multimedia management application. These valuable data may be beneficial and helpful in an enhancement process for the multimedia files. But nowadays the information goes to waste for lack of bridge or integrity application between the multimedia databases and the multimedia enhancement facility.

### SUMMARY OF THE INVENTION

It is, therefore, a method and system of enhancing multimedia files are provided herein. A multimedia database is established for connecting a multimedia management facility and a multimedia enhancement facility. Thus, the information is transparently inherited from the multimedia database to the multimedia enhancement facility.

It is also, therefore, a process and system of enhancing photo files are provided herein. Based on descriptors from a photo database, a photo enhancement facility recommends one or more solutions for a user. Such an enhancement process reduces the users' domain knowledge requirement and manual effort for enhancing the photo files.

It is also, therefore, a process and system of enhancing photo files are provided herein. The multimedia database is provided for taking advantages of exist assets collected by the conventional management application, significantly increasing its value.

According to one aspect of the present invention, one embodiment of the present invention is a multimedia enhancement system and process thereof. Collecting means is configured for collecting a plurality of first information related to a plurality of multimedia files. Storing means is configured for accepting the first information and storing the first information in a form of a plurality of descriptors. Enhancing means is configured for requesting one from the multimedia files and enhancing the requested multimedia file in reference to the descriptors. Besides, the storing means further accepts at least a second information as feedback from the enhancing means. Thus, the enhancement method includes collecting a plurality of information related to a plurality of multimedia files; storing the first information in a form of a plurality of descriptors, such as tags; and enhancing one of the multimedia files in reference to the corresponding descriptors.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic block diagram illustrating an embodiment of multimedia enhancing system in accordance with the present invention; and

FIG. 2 is a schematic flowchart illustrating a process of multimedia enhancement in accordance with the present invention.

### DETAILED DESCRIPTION OF THE EMBODIMENTS

The following description provides specific details for a through understanding of, and enabling description for, embodiments of the invention. However, one skilled in the art will understand that the invention may be practiced without these detailed. In other instances, well known structures and functions have not been shown or described in detailed to avoid unnecessarily obscuring the description of the embodiments of the invention.

The present invention can be included in an article of manufacture (e.g., one or more computer program products) having, for instance, computer usable multimedia. The multimedia has embodied therein, for instance, computer readable program code means for providing and facilitating the capabilities of the present invention. The article of manufacture can be included as a part of a computer system or sold separately.

Additionally, at least one program storage device readable by a machine embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

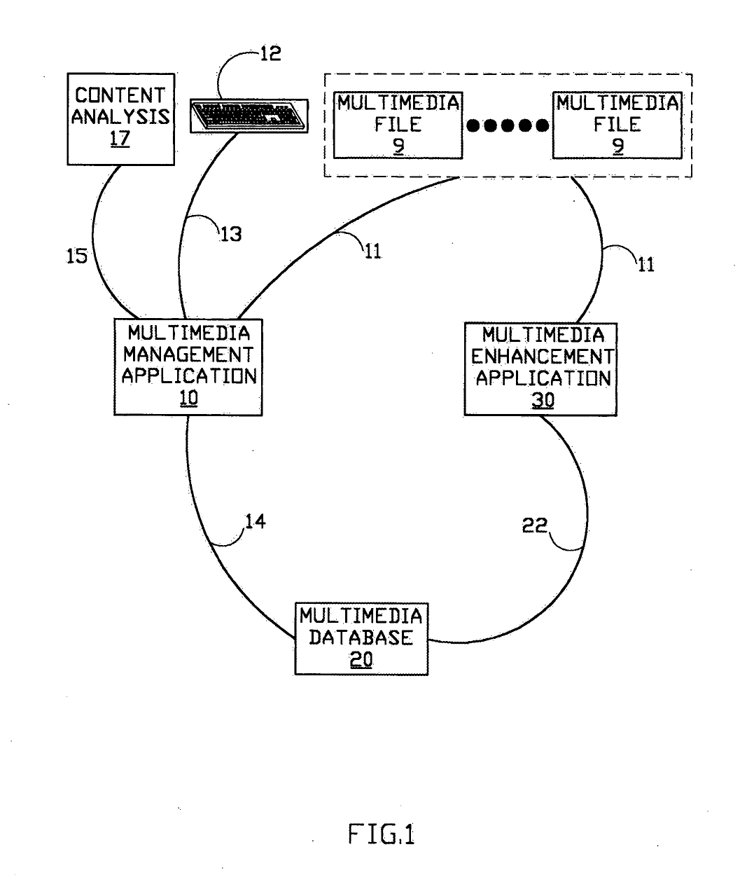

FIG. 1 is a schematic block diagram illustrating an embodiment of multimedia enhancing system in accordance with the present invention. Generally, a multimedia management 10 collects a wide variety of information embodied in or added into multitudes of multimedia files. In one embodiment, the multimedia management 10 obtains information 11 from multimedia files 9 in multitudes standard formats such as EXIF (Exchangeable Image file Format), information 13 from manual addition, such as a keyboard 12, and information 15 from pre-process of other application, for example, from a content analysis 17, but not limited as describe above. In the embodiment, the information 11 may be various metadata in the file headers of the multimedia files. On the other hand, the information 13 may be many keyword tags assigned by users for some multimedia files. Furthermore, the information 15 may be properties, such as histogram of image data by content analysis 17 done on the multimedia files.

According to one of aspects of the invention, the information 11, 13 and 15 aforementioned, from different resources, are outputs to be stored in the form of descriptors in a multimedia database 20. In the embodiment, the output 14 is stored in the form of the tags, binary data or both above, but not limited as describe above. Besides the output 14, the multimedia database 20 further accepts and stores descriptors 22 extracted from one or more recommended solutions associated with the performance enhancement of multimedia data. In one embodiment, the output 14 can be integrated with the descriptors 22 in the multimedia database 20. In other words, multimedia database 20 provides “learning-enabled” knowledge via the combination of output 14 and the descriptors 22 for multimedia enhancement.

Furthermore, a multimedia enhancement application 30 provides tools or functions, but not limited to, such as “adjust overall exposure”, “enhance lighting” or “adjust saturation”, etc. for users to improve the performance of image data and other audio-related and video-related tools for improving the performance of music data and video data, respectively. Generally, multimedia data in accompanying with the “original” information 11 from multimedia files 9 in the standard formats are also extracted by the multimedia enhancement application 30. According with the aspect of the present invention, the multimedia database 20 provides the multimedia enhancement application 30 with the descriptors 22. Thus, when the multimedia enhancement application 30 currently opens a multimedia file, it will query the multimedia database 20 if the information 11, 13 or 15 associated with the requested multimedia file by the multimedia enhancement application 30 has been stored in the multimedia database 20. The multimedia enhancement application 30 then provides one or more sets of recommended solution based on the “learning” information. Of course, the multimedia database 20 may provide approximate the descriptors 22 even though there is no identical the descriptors 22 for the requested multimedia file.

Accordingly, users may improve the requested multimedia data, by the tools or functions, in the multimedia enhancement application 30, based on selecting one recommended solution or creating new one according to their own knowledge. It is understandable that users also can modify some information embodied in the recommended solution. Then the requested multimedia file is improved and output to other facilities (storage multimedia or printer). On the other hand, the final solution adopted for the requested multimedia file can be recorded as the descriptors 22 and stored back to the multimedia database 20.

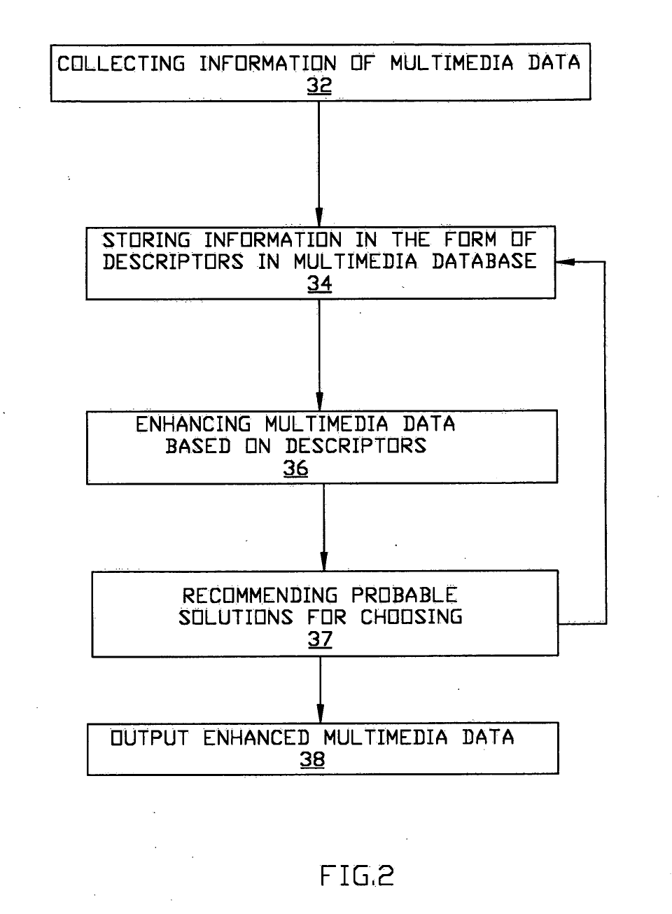

FIG. 2 is a schematic flowchart illustrating a process of multimedia enhancement in accordance with the present invention. Firstly, various information of multimedia data in one or more multimedia files is collected via a collecting facility (step 32), such as a multimedia management application installed and operated under an appropriate operating system in a computing facility. The various information may be extracted from one or more multimedia files, such as photo files, audio files or video files, added or prepared by other multimedia management application.

Next, the various information is stored in the form of descriptors into a storage facility (step 34), such as a multimedia database established in a memory or a hard disk. In one embodiment for photo files, descriptors in the form of metadata, such as EXIF tags, are employed in the multimedia database. Alternatively, descriptors in the form of binary data are also employed in the multimedia database, such as histogram, etc..

In one embodiment, the information extracted from a photo file includes, but not limited to, program mode such as item of portrait, landscape, two people, group photo or macro, focal length, aperture, ISO value, shutter speed, metering mode, AF area mode, white balance or focus point, etc. The information aforementioned is useful for subsequent processing and stored in the form of descriptors in the multimedia database.

In another embodiment for audio files, descriptors are employed in the multimedia database for music data, in which include audio-related feature indices, such as intensity, spectral centroid, tempo (related to the speed of music data), beat onset (associated with the timing and strength characteristics provided by musical instrument), and micro-change indices (associated with local predominant changes or track volume fluctuations or the appearance of instruments), but not limited to.

In further another embodiment for video files, descriptors are employed in the multimedia database for video data, in which include video-related feature indices, scene change, on/off of camcorder, measures of color including scalable, color layout, dominant color, measures of motion including motion trajectory and motion activity, camera motion and face recognition, but not limited to.

Next, the information in the form of descriptors is applied on the enhancement of one or more requested multimedia data, such as photo data, and utilized on the enhancement process of the request multimedia data (step 36). For example, for one requested photo data, the multimedia database provides the multimedia enhancement application with the tags. Based on these tags for camera mode and time, the multimedia enhancement application determines which mode, scenery mode and broad daylight, is used for the request photo data. Furthermore, under the selected mode and the tags for exposure value and the binary data for histogram, the multimedia enhancement application further determines whether the requested photo suffers from an issue of exposure.

In another embodiment for one requested music data, the multimedia database provides the multimedia enhancement application with the descriptors. For example, based on these descriptors for beat onset, the multimedia enhancement application determines which instrument, drum or bass, is used for the request music data. In further another embodiment for one requested video data, the multimedia database provides the multimedia enhancement application with the descriptors. For example, based on these descriptors for skin color detection, the multimedia enhancement application determines which scenes, theme or background, is used for the requested video data.

Next, the multimedia enhancement application recommends one or more sets of probable solutions for the users (step 37) to choose. These solutions may include the probable tools or functions, and the order in use, and so on.

Once the solution on the requested photo data is selected, the adopted solution recording the associated information is stored back into the multimedia database. Besides, an enhanced multimedia data, such as the enhanced photo data is output (step 38). For example, users improve the requested photo data by using some tools or functions according to the selected solution in the multimedia enhancement facility, then the values or items corresponding to those tools and functions are stored in the form of descriptors back to the multimedia database. Thus, the similar or identical issues can be reminded in reference to the updated tags from the multimedia database.

Accordingly, via the multimedia database, the various information collected by the multimedia management facility can be sufficiently utilized by the multimedia enhancement facility. Besides, the proficiency used and built by the multimedia enhancement facility can be feedback back to the multimedia database for the application or query next time. Thus, the multimedia database according to the aspect of the present invention provides an effective bridge between multimedia management and the multimedia enhancement facilities. The implements in accordance with the aspects of the present invention reduce the users' domain knowledge requirement and manual effort for enhancing the multimedia files.

Accordingly, one of the aspects of the present invention provides a program storage device readable by at least one computer, which includes a first program of instructions to perform collecting a plurality of first information related to a plurality of multimedia files; a second program of instructions to perform accepting the first information and storing the first information in a form of a plurality of descriptors, such as tags; and a third program of instructions requesting one from the multimedia files and enhancing said requested multimedia file in reference to the descriptors. Besides, the storing means further accepts at least a second information as feedback from the enhancing means. Thus, the enhancement method includes collecting a plurality of information related to a plurality of multimedia files; storing the first information in a form of a plurality of descriptors, such as tags; and enhancing one of the multimedia files in reference to the corresponding descriptors.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. An multimedia enhancement system, comprising:
collecting means for collecting a plurality of first information related to a plurality of multimedia files;
storing means for accepting said first information and storing said first information in a form of a plurality of descriptors; and
enhancing means for requesting one from said multimedia files and enhancing said requested multimedia file in reference to said descriptors in said storing means.

2. The multimedia enhancement system in accordance with the claim 1, wherein said collecting means collects a portion of said first information extracted from said multimedia files.

3. The multimedia enhancement system in accordance with the claim 1, wherein said collecting means collects a portion of said first information input by a user.

4. The multimedia enhancement system in accordance with the claim 1, wherein said collecting means collects a portion of said first information prepared by exterior application.

5. The multimedia enhancement system in accordance with the claim 1, wherein said collecting means is a multimedia management application.

6. The multimedia enhancement system in accordance with the claim 1, wherein said storing means further accepts at least a second information from said enhancing means.

7. The multimedia enhancement system in accordance with the claim 6, wherein said second information is associated with a solution determined by said enhancing means for enhancing said requested multimedia file.

8. The multimedia enhancement system in accordance with the claim 1, wherein said storing means is a multimedia database.

9. The multimedia enhancement system in accordance with the claim 1, wherein said enhancing means comprises providing a plurality of tools and functions for enhancing said requested multimedia file.

10. The multimedia enhancement system in accordance with the claim 1, wherein said forms of descriptors are the form of metadata.

11. The multimedia enhancement system in accordance with the claim 1, wherein a solution adopted by said requested multimedia file and at least a second information corresponding to said solution is stored into said storing means.

12. A program storage device readable by at least one computer, said program storage device comprising:
a first program of instructions to perform collecting a plurality of first information related to a plurality of multimedia files;
a second program of instructions to perform accepting said first information and storing said first information in a form of a plurality of descriptors; and
a third program of instructions to perform requesting one from said multimedia files and enhancing said requested multimedia file in reference to said descriptors in said second program.

13. The program storage device in accordance with the claim 12, wherein said first information comprises metadata extracted from said multimedia files.

14. The program storage device in accordance with the claim 12, wherein said first information comprises provided by a user.

15. The program storage device in accordance with the claim 12, wherein said first information comprises prepared by an exterior program of instructions.

16. The program storage device in accordance with the claim 12, wherein said second program of instructions comprises storing a plurality of second information from execution of said third program of instructions.

17. The program storage device in accordance with the claim 12, wherein said form of descriptors are the form of metadata.

18. An enhancement method, comprising:
collecting a plurality of first information related to a plurality of multimedia files;
storing said first information in a form of a plurality of descriptors; and
enhancing one of said multimedia files in reference to said corresponding descriptors.

19. The enhancement method in accordance with the claim 18, further comprising creating an adopted solution recording said corresponding descriptors related to said enhanced multimedia file and storing said adopted solution.

20. The enhancement method in accordance with the claim 18, wherein said collecting step comprises collecting a portion of said first information extracted from said multimedia files.

21. The enhancement method in accordance with the claim 18, wherein said collecting step comprises collecting a portion of said first information input by a user.

22. The enhancement method in accordance with the claim 18, wherein said collecting step comprises collecting a portion of said first information prepared by exterior application.

23. The enhancement method in accordance with the claim 18, wherein said form of descriptors are the form of metadata.
